(19) United States
(12) Patent Application Publication
(10) Pub. No.: US 2016/0299226 A1
(43) Pub. Date: Oct. 13, 2016

(54) METHOD FOR RECONSTRUCTING A SURFACE OF A PIECE

(71) Applicant: COMMISSARIAT A L'ENERGIE ATOMIQUE ET AUX ENERGIES ALTERNATIVES, Paris (FR)

(72) Inventors: Ekaterina IAKOVLEVA, LIMOURS (FR); Sylvain CHATILLON, PALAISEAU (FR); Steve MAHAUT, SAINT-MICHEL-SUR-ORGE (FR)

(21) Appl. No.: 15/036,758

(22) PCT Filed: Nov. 20, 2014
(86) PCT No.: PCT/EP2014/075145

§ 371 Date: May 13, 2016

(30) Foreign Application Priority Data
Nov. 22, 2013 (FR) 1361502

(51) Int. Cl. G01S 15/89

(52) U.S. Cl. CPC G01S 15/89

(57) ABSTRACT

A method for reconstructing a profile of a piece, by using an emitter/receiver device comprising N elements, the device being adapted for emitting a wave propagating in a medium, comprises at least the following steps: A) gathering the signals Si,j reflected by the piece subjected to the wave, B) measuring the flight time of the surface echo tj for several emitter-receiver pairs {Eᵢ, Rⱼ}, C) constructing the family of ellipses Γ_{c} associated with these emitter pairs {Eᵢ, Rⱼ}, D) calculating the envelope of the family of ellipses Γ_{c}, E) determining on the basis of this envelope the points Pi constituting the profile of the piece.

The subject of the invention relates to a method for reconstructing the profile of a piece by means of a for example multielement ultrasound transducer or sensor, positioned in a medium allowing the propagation of a wave.

The invention applies for example in respect of electronic scans using an emitter element different from a receiver element. It is also used in acquisitions using all the signals emitted and transmitted element by element of the transducer, of total capture or FMC (Full Matrix Capture) type. The technique according to the invention is notably used for two-dimensional or three-dimensional reconstructions of the profile of a part.

Multielement ultrasound transducers are increasingly being employed for the non-destructive testing of industrial components. This technology makes it possible to adapt and control an ultrasound beam within a part of known geometry by applying delays on emission and on reception to each of the elements of the transducer. When using imaging procedures which are based on the calculation of delay laws or flight times, it is necessary to have perfect knowledge, or the most complete possible knowledge, of the geometry of the inspected part. If this knowledge is lacking, the imaging procedures become inoperative or quite unreliable, and their implementation requires the prior application of a surface reconstruction technique.

In the case of immersion tests, the part whose profile one wishes to reconstruct and the sensor are submerged in a fluid, often in water which serves as couplant.

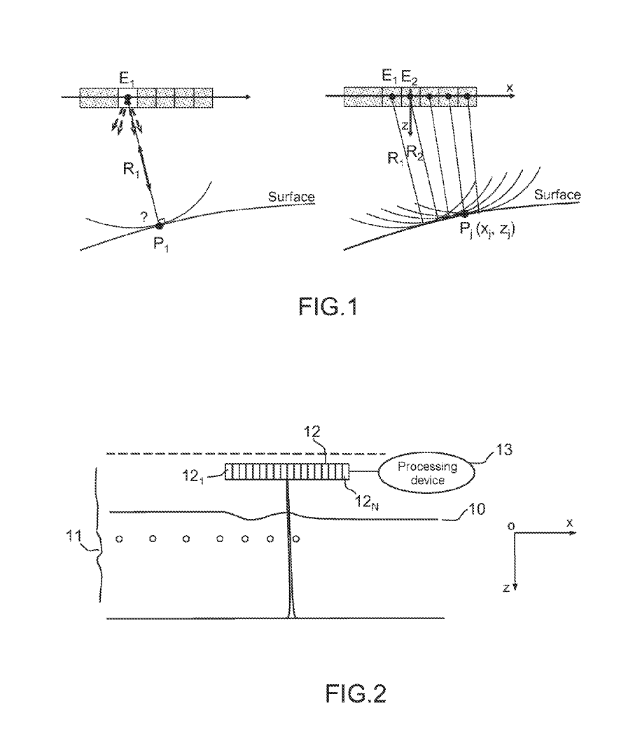

A first technique known from the prior art is based on a measurement of the flight times between the elements of the sensor and the surface of the part, and the application of a reconstruction algorithm. The measurement of the flight times is carried out on the signals received in the course of a simple electronic scan. FIG. 1 represents this reconstruction technique for an element by element combined emission/reception acquisition, or simple electronic scan. The case of a two-dimensional reconstruction is considered. For a linear transducer, the assumption is made that the size of an element of the transducer is small compared with the couplant height and compared with the evolution of the profile of the inspected part. On the basis of this assumption, it is possible to limit the description of each element of the transducer by its geometric center. The technique employed in the reconstruction consists in emitting and in receiving with a single element Ej with center Cⱼ, and then in measuring, at the level of the same element, the flight time of the surface echo, tⱼ. The measured time which corresponds to the shortest out-and-back time taken by the ultrasounds to return to the transducer: it therefore corresponds to a specular reflection at normal incidence on the surface of the part. The surface point Pⱼ intercepted by this radius belongs to a circle, situated in a plane XZ, with center Cⱼ and radius Rⱼ=tⱼ·v/2, where v is the propagation speed in the couplant. Moreover, the surface S of the part is locally tangent to this circle at the point Pⱼ. At this juncture, the exact position of the point Pⱼ on the circle Cⱼ is not known. By carrying out this operation on each element of the translator, a family of circles Γ_{c}={C₁,C₂, . . . } is obtained in the plane XZ. By construction, the surface of the part is locally tangent to each of the circles of this family. The surface sought is the envelope of the family of circles Γ_{c}. It can be calculated analytically if the curve described by the points Cⱼ is known. Indeed, in the case of a linear transducer, the equation of the circle with center C(cₓ,0) is given by:

F(x,z,cₓ)=(x−cₓ)²+z²−R²(cₓ)=0, x and z being the coordinates of the point P.

By assuming that the family Γ_{c} depends on the parameter cₓ in a differentiable manner, on the basis of the system of equations for calculating a family of curves:

$$\{ \begin{matrix}F ( x , y , λ ) = 0 \\ \frac{\partial F}{\partial λ} ( x , y , λ ) = 0\end{matrix} \qquad ( A .1 )$$

we obtain the coordinates x and z of the point P of the profile in the following form:

x=cₓ−R·R′_{c}_{ₓ}

z=R\sqrt{1−(R′_{c}_{ₓ})²} (1.0)

where R′_{c}_{ₓ} is the derivative of R with respect to cₓ.

In the discrete case, for a linear transducer with N elements, the coordinates of the point Pⱼ in the frame of the sensor are given by:

$${x}_{j} = {c}_{x , j} - {R}_{j} \cdot {R}_{j}^{′} \\ {z}_{j} = {R}_{j} \sqrt{1 - {( {R}_{j}^{′} )}^{2}} \\ {R}_{j}^{′} = \frac{{R}_{j + 1} - {R}_{j}}{{c}_{x , j + 1} - {c}_{x , j}} \qquad ( 1.1 )$$

with j=1,2 . . . we obtain N−1 point of the surface. R′ⱼ corresponds to the discrete derivative of the radii Rⱼ with respect to the abscissae of the elements.

Under the same assumptions as previously, this reconstruction can also be carried out with the aid of a single-element sensor by carrying out a scan along the axis OX.

To summarize, the algorithm for reconstructing the surface of the part is as follows:
1) measure the flight time of the surface echo, tⱼ, for each emitter-receiver pair Ei, Ri; this flight time can be obtained by extracting the time of the maximum of the envelope of the signal received, for example,
2) construct the family of circles for the set of emitter-receiver pairs Ei, Ri, by calculating circle centers Cⱼ and radii Rⱼ=tⱼ·v/2,
3) calculate the envelope of the family of circles by calculating the points Pⱼ using the formula (1.1).

The same approach can be applied to reconstruct a 3D three-dimensional input surface with the aid of a 2D two-dimensional sensor, or by displacement along an axis X-Y of a single-element sensor. In this case, for each geometric center C(cₓ,c_{y},0), we seek to calculate the envelope of a family of spheres Σ_{c}_{ₓ}_{,c}_{_{y}} having two parameters cₓ and c_{y}, with equation

F(x,y,z,cₓ,c_{y})=(x−cₓ)²+(y−c_{y})²+z²−R²(cₓ,c_{y})=0

In the continuous case, on the basis of the system of equations specific to the envelope of a two-parameter family of surfaces Σ_{λ,μ} with equation F(x,y,z,λ,μ)=0

$$\{ \begin{matrix}F ( x , y , z , λ , μ ) = 0 \\ \frac{\partial F}{\partial λ} ( x , y , z , λ , μ ) = 0 \\ \frac{\partial F}{\partial μ} ( x , y , z , λ , μ ) = 0\end{matrix} , \qquad ( A .2 )$$

we obtain the coordinates x, y, z of the point P of the surface of the part in the frame of the sensor in the following form:

$$x = {c}_{x} - R \cdot \frac{\partial R}{\partial {c}_{x}} ( {c}_{x} , {c}_{y} ) \\ y = {c}_{y} - R \cdot \frac{\partial R}{\partial {c}_{y}} ( {c}_{x} , {c}_{y} ) \\ z = R \sqrt{1 - {( \frac{\partial R}{\partial {c}_{x}} )}^{2} - {( \frac{\partial R}{\partial {c}_{y}} )}^{2}} \qquad ( 1.2 )$$

One of the drawbacks of this technique is that the electronic-scan mode of emission, a single element of the transducer per shot, sometimes returns surface echoes whose amplitudes are too weak to carry out a reliable measurement of the flight times. This signifies that, locally, the angle formed by the tangent to the profile and the axis of the sensor is too big, and that the reflected wave does not necessarily reach a receiver of the transducer. The entirety of the flight times between the sensor and the surface is therefore not measured and the reconstructed geometry of the part may exhibit significant disparities with respect to the expected profile. Differences may also appear when the surfaces are too irregular and when they generate, for example, several criss-crossed echoes.

A second technique known from the prior art is based on the processing of the imaging known by the abbreviation FAP for Focusing at All Points which applies mainly to acquisitions of signals on all the elements forming the reception sensor, of aforementioned total capture or “Full Matrix Capture” type. One of the advantages of FMC acquisition is that it affords access to data that are often much richer and more complete than those provided by simple electronic scans, notably in the case of overly irregular surfaces. Recall that for a multielement with N elements, the FMC acquisition consists in recording a set of N×N elementary signals, Sᵢⱼ(t), with i,j=1, . . . , N, where the subscript i denotes the index number of the emitter element of a wave and the subscript j that of the receiver element of the signals emitted after reflection of the wave on the part.

The complete profile of the part is then obtained in three steps:
1) FMC acquisition with an acquisition window long enough to contain the echoes of the surface,
2) construction of an FAP image of the surface, assuming for example that the medium propagating the wave is water, and
3) extraction of the profile by detecting shapes in the FAP image obtained.

The set of points obtained then forms the sought-after profile, and can thereafter be smoothed. The number of points forming the profile is not limited by the number of elements N of the sensor. Once the surface has been reconstructed, the latter is used to visualize possible defects, either with the same FMC acquisition, or by using the part obtained by the technique of computer-aided design CAD. Standard imaging procedures can also be implemented.

One of the drawbacks of this technique is that despite everything the production of an FAP image remains greedy in terms of calculation time. For N×N acquired signals and for a reconstruction zone possessing M calculation points, the complexity of the calculation will therefore be O(M.N²). Thus, for high-resolution images the calculation time becomes very significant. Moreover, extraction of the profile requires the availability of image processing tools such as, for example, tools for the recognition of shapes which are generally parametric and therefore the quality of the reconstructed profile depends directly on the parameters chosen.

Patent FR 2 379 823 describes a procedure and a device making it possible to determine the geometric configuration of the submerged portion of icebergs by using notably a reflection point corresponding to a portion of the iceberg by defining the contour of the iceberg as an envelope of ellipses.

Therefore, a need currently exists to have available a simple and fast technique for reconstructing the profile of a part with the aid of an immersed sensor.

In the subsequent description, the word “offset” is used to designate the distance, considered in the frame of a transducer, separating an emitter from a receiver of the transducer.

The word “transducer” designates a device composed of several ultrasound or other wave emitter/receiver elements.

The subject of the invention relates to a method for reconstructing a profile of a piece, by using an emitter/receiver device comprising N elements, said device being adapted for emitting a wave propagating in a medium, comprising at least the following steps:
A) gathering the signals S_{i,j} reflected by the part subjected to the wave,
B) measuring the flight time of the surface echo tⱼ for several emitter-receiver pairs {Eᵢ, Rⱼ},
C) constructing the family of ellipses Γ_{c} associated with these emitter pairs {Eᵢ, Rⱼ}, by calculating midpoints Cⱼ, with:

a=t·v/2

b=\sqrt{a²−h²}

where a is the length of the semi-major axis, b the length of the semi-minor axis of the ellipse, h=|\vec{h}|/2 is the distance from the center to the ellipse focus, t the flight time of the surface echo, v the speed of propagation of the wave in the medium,
D) calculating the envelope of the family of ellipses Γ_{c},
E) determining on the basis of this envelope the coordinates (xⱼ, zⱼ) of the points Pi constituting the profile of the piece,
   in the frame of the emitter-receiver device in the following manner:

$${x}_{j} = {c}_{x , j} + {a}_{j} \cdot {Δ}_{j}$$

$${z}_{j} = {b}_{j} \cdot \sqrt{1 - {Δ}_{j}^{2}}$$

$${Δ}_{j} = \frac{- {b}_{j} + \sqrt{{b}_{j}^{2} - 4 {a}_{j} {b}_{j}^{′} ( {a}_{j}^{′} {b}_{j} - {a}_{j} {b}_{j}^{′} )}}{2 ( {a}_{j}^{′} {b}_{j} - {a}_{j} {b}_{j}^{′} )}$$

where a′ⱼ and b′ⱼ are respectively the discrete derivatives of a and b at the midpoint Cⱼ,

the values of a′ⱼ and/or of b′ⱼ being obtained, for example, on the basis of the formulae:

$${a}_{j}^{′} = \frac{{a}_{j + 1} - {a}_{j}}{{c}_{x , j + 1} - {c}_{x , j}}$$

$$or$$

$${a}_{j}^{′} = \frac{{a}_{j + 1} - {a}_{j - 1}}{{c}_{x , j + 1} - {c}_{x , j - 1}}$$

$$and \text{/} or$$

$${b}_{j}^{′} = \frac{{a}_{j} {a}_{j}^{′} - {h}_{j}}{{b}_{j}}$$

C_{x,j+1}; Cₓⱼ₋₁ are the coordinates of the midpoint Cⱼ₊₁ or Cⱼ₋₁.

According to a variant, emitter-receiver pairs {Eᵢ, Rⱼ} are used such that the distance k is identical for all the emitter-receiver pairs {Eᵢ, Rⱼ} and the previous steps are executed to obtain the profile of the piece.

It is possible to use a two-dimensional emitter-receiver device, and to determine the envelope of a two-parameter ellipsoid family.

According to a variant, the set of signals associated with one and the same emitter Eᵢ is grouped together and the signals for the (N−1) receivers Rⱼ are acquired, with i different from j.

It is possible to use a two-dimensional emitter-receiver device, and to determine the envelope of a two-parameter ellipsoid family.

The wave used for the implementation of the method is an ultrasound wave.

According to a variant embodiment, to determine the flight time corresponding to the surface echo, a threshold value S is used, the envelope of the signal received is compared and if the value of the envelope is less than the threshold value, an interpolation procedure based on the two closest values is used to find the missing value.

Other characteristics and advantages of the method according to the invention will be more clearly apparent on reading the description which follows of an exemplary embodiment given by way of wholly nonlimiting illustration, together with the figures which represent:

FIG. 1, a diagram for a first technique according to the prior art,

FIG. 2, a configuration of device for the reconstruction of a profile of a part,

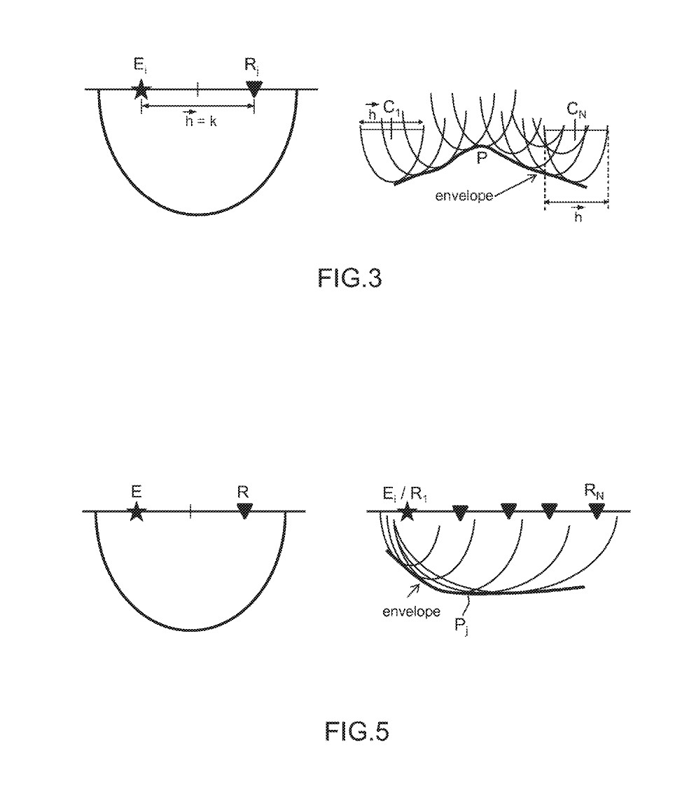

FIG. 3, an exemplary reconstruction of a surface according to a first variant embodiment,

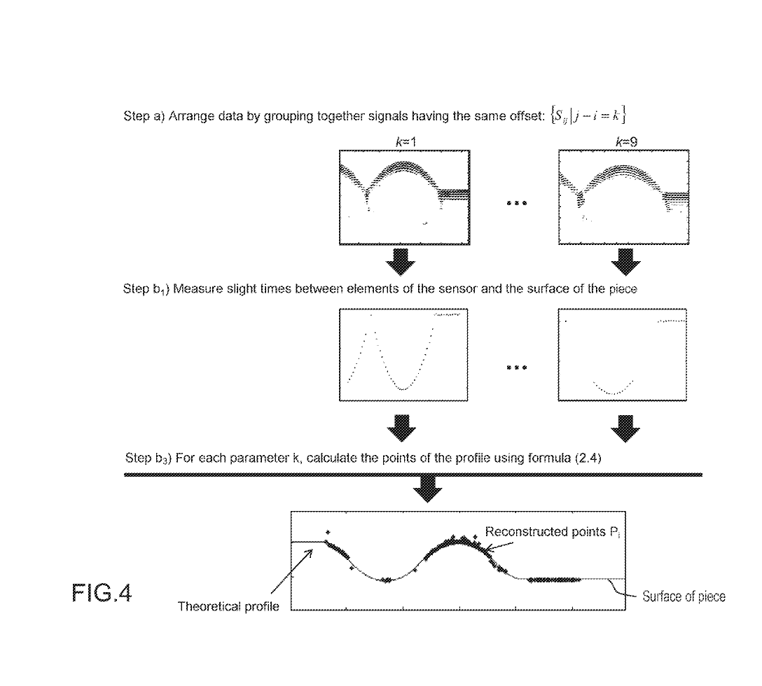

FIG. 4, an exemplary flow of the steps of the method of FIG. 3,

FIG. 5, an exemplary reconstruction of a surface of a part according to a second variant embodiment,

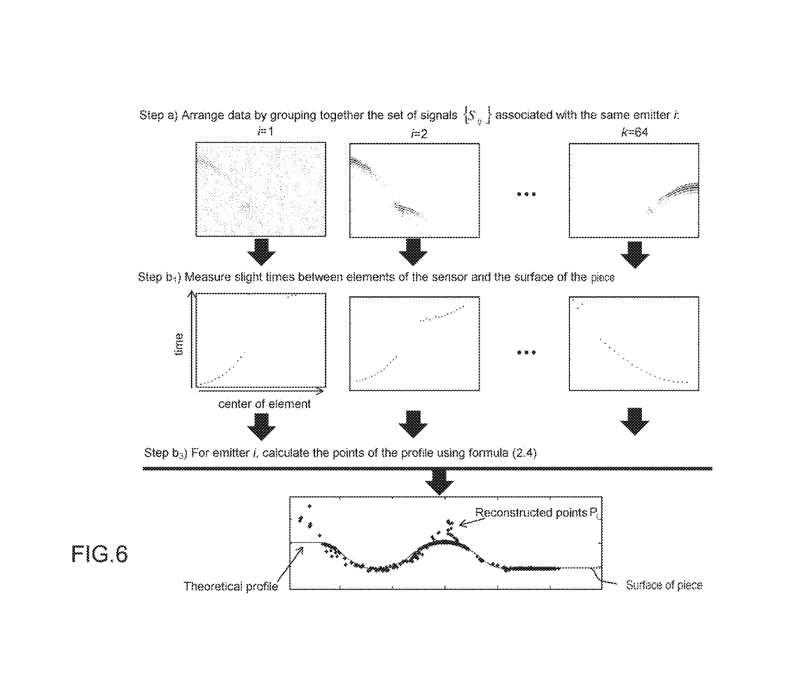

FIG. 6, an exemplary flow of the steps for the implementation of the method of FIG. 5.

In order to better elucidate the subject matter of the invention, the examples which follow are given for the reconstruction of the profile of an immersed piece and of a multielement sensor working with ultrasound waves, the whole being immersed in water used as couplant medium.

FIG. 2 represents a piece 10 with a sinusoidal profile, immersed in a liquid 11, a multielement sensor 12 which is linked to a signal processing device 13, notably adapted to perform the measurement of the flight time and to execute the steps for the determination of the profile. An element 12i comprises for example an emitter Ei and a receiver Ri.

The method according to the invention is a technique for determining the profile of a piece with the aid of an immersed transducer based on a measurement of the flight times between the elements of the sensor and the piece, for example its surface. The measurement of the flight times is carried out on the signals received in the course of an FMC acquisition or of an electronic scan by considering an element of the transducer during emission and an element of the transducer during reception of different rank. A cartesian plane is referred to, taken in the frame of the transducer.

Recall that for a multielement with N elements, FMC acquisition consists in recording a set of N×N elementary signals, Sᵢⱼ(t), with i,j=1, . . . , N, where the subscript i denotes the index number of the emitter element and the subscript j that of the receiver element. For this type of acquisition, the reconstruction algorithm can be applied to various suites of data. Indeed, the elementary signals Sᵢⱼ(t), i,j=1, . . . , N received on the sensor elements can be rearranged in the chosen reconstruction domain, two examples being explained below by way of wholly nonlimiting illustration.

FIG. 3 shows diagrammatically the reconstruction of a profile of a piece according to a first mode of implementation of the method according to the invention, called reconstruction by offset.

Reconstruction by common offset is applied to the data received on a sensor by grouping together the signals S_{i,j} having the same offset k, that is to say the same distance between an emitter Eᵢ and a receiver Rⱼ. The data are represented in the offset \vec{h} and midpoint Cᵢ coordinates defined by:

\vec{h}=\vec{EᵢRⱼ} and Cᵢ=(Eᵢ+Rⱼ)/2 (2.1)

Under the assumption of elements of small dimension as compared with the couplant height (distance between the sensor and the input surface of the wave) and as compared with the evolution of the profile of the inspected piece, the total flight time between the emitter E, the point P of the surface and the receiver R defines an ellipse with foci E (emitter) and R (receiver) with equation:

|\vec{EP}|+|\vec{PR}|=t·v (2.2)

where v is the propagation speed in the couplant. The lengths of the semi-major axis a and of the semi-minor axis b of the ellipse are given by:

a=t·v/2

b=\sqrt{a²−h²} (2.3)

where h=|\vec{h}|/2 is the distance from the center to the ellipse focus.

In the case of a 2D reconstruction, the sought-after profile is the envelope of the family of ellipses Γ_{c} associated with each emitter-receiver pair {(Eᵢ, Rⱼ)}, i,j=1,2, . . . , having the same offset \vec{h}, as illustrated by FIG. 3.

For a linear transducer, the equation of an ellipse with center C(cₓ,0) is given by:

$$F ( x , z , {c}_{x} ) = \frac{{( x - {c}_{x} )}^{2}}{{a}^{2} ( {c}_{x} )} + \frac{{z}^{2}}{{b}^{2} ( {c}_{x} )} - 1 = 0$$

In the continuous case, by assuming that the family Γ_{c} depends on the parameter cₓ in a differentiable manner and with an offset \vec{h}≠0, on the basis of the system of equations (A.1), we obtain the coordinates x and z of the point P of the profile of the piece in the form:

$$x = {c}_{x} + a \cdot Δ$$

$$z = b \cdot \sqrt{1 - {Δ}^{2}}$$

$$Δ = \frac{- b + \sqrt{{b}^{2} - 4 {ab}^{′} ( {a}^{′} b - {ab}^{′} )}}{2 ( {a}^{′} b - {ab}^{′} )}$$

where a′ and b′ are respectively the derivatives of a and of b with respect to cₓ and b′ is given by:

$${b}^{′} = \frac{{aa}^{′}}{\sqrt{{a}^{2} - {h}^{2}}} = \frac{{aa}^{′}}{b} \qquad ( {2.3}^{′} )$$

In the discrete case, for an FMC acquisition, the reconstruction algorithm described hereinabove is applied to the set of elementary signals {Sᵢⱼ,i,j=1, . . . , N|j−i=k}, with 0≦k≦N−1. The method will perform N−1 independent reconstructions.

For the reconstruction where the value of the offset is positive, k>0, the coordinates of a point Pⱼ, j=1,2 . . . , in the frame of the sensor are given by:

$${x}_{j} = {c}_{x , j} + {a}_{j} \cdot {Δ}_{j} \\ {z}_{j} = {b}_{j} \cdot \sqrt{1 - {Δ}_{j}^{2}} \\ {Δ}_{j} = \frac{- {b}_{j} + \sqrt{{b}_{j}^{2} - 4 {a}_{j} {b}_{j}^{′} ( {a}_{j}^{′} {b}_{j} - {a}_{j} {b}_{j}^{′} )}}{2 ( {a}_{j}^{′} {b}_{j} - {a}_{j} {b}_{j}^{′} )} \qquad ( 2.4 )$$

where a′ⱼ and b′ⱼ are respectively the discrete derivatives of a and b at the midpoint Cⱼ. The value of a′ⱼ is obtained, for example, using the following formula:

$${a}_{j}^{′} = \frac{{a}_{j + 1} - {a}_{j}}{{c}_{x , j + 1} - {c}_{x , j - 1}} \qquad ( 2.5 )$$

or by the centered discrete differentiation formula:

$${a}_{j}^{′} = \frac{{a}_{j + 1} - {a}_{j - 1}}{{c}_{x , j + 1} - {c}_{x , j - 1}} \qquad ( {2.5}^{′} )$$

The value of b′ⱼ can be obtained through the formulae (2.5) or (2.5′) or through (2.3′).

To summarize, the method allowing reconstruction by offset having one and the same value for all the emitter/receiver pairs comprises for example the following steps, FIG. 5:

a) arranging the data received by grouping together the signals Sᵢⱼ {Sᵢⱼ|j−i=k} received on the transducer for the emitter/receiver pairs having the same offset:

b) for each parameter or offset k, 0<k≦N−1:
b1) measuring the flight time of the surface echo, tⱼ, for each emitter-receiver pair {Eᵢ, Rⱼ},
b2) constructing the family of ellipses Γ_{C} associated with these emitter-receiver pairs {Eᵢ, Rⱼ} by calculating midpoints Cⱼ, the length of the semi-major axis aⱼ and the length of the semi-minor axis bⱼ which are given by the equation (2.3),
b3) calculating the envelope of the family of ellipses by calculating the points Pⱼ using the formula (2.4),

c) determining the profile of the piece.

Without departing from the scope of the invention, the same approach can be applied to reconstruct a 3D three-dimensional input surface with the aid of a 2D sensor or by displacement in the axis X-Y of a single-element transducer. In this case, for each midpoint C(cₓ,c_{y},0) and a fixed offset \vec{h}(hₓ,h_{y},0)≠0, we shall calculate the envelope of the family of ellipsoids Σ_{c}_{ₓ}_{,c}_{_{y}} having two parameters cₓ and c_{y}, with equation

$$F ( x , y , z , {c}_{x} , {c}_{y} ) = \frac{{X}^{2}}{{a}^{2} ( {c}_{x} , {c}_{y} )} + \frac{{Y}^{2}}{{b}^{2} ( {c}_{x} , {c}_{y} )} + \frac{{z}^{2}}{{b}^{2} ( {c}_{x} , {c}_{y} )} - 1 = 0 \\ X = \frac{1}{\vert \vec{h} \vert} ( {h}_{x} ( x - {c}_{x} ) + {h}_{y} ( y - {c}_{y} ) ) \\ Y = \frac{1}{\vert \vec{h} \vert} ( - {h}_{y} ( x - {c}_{x} ) + {h}_{x} ( y - {c}_{y} ) ) \qquad ( 2.6 )$$

with hₓ, coordinates of the offset in the transducer frame x axis, h_{y}, coordinates of the offset in the transducer y axis.

By solving the system of equations, known to a person skilled in the art, for calculating an envelope of a family of surfaces, equation A.2, we obtain the coordinates of the various points P defining the surface of the piece in the sensor frame.

FIG. 4 shows diagrammatically the reconstruction of the profile of a surface according to a second variant embodiment. The reconstruction of the piece profile is applied to the data arranged by shot point, that is to say to the data grouping together the set of signals {Sᵢ₁,Sᵢ₂, . . . , S_{iN}} associated with one and the same emitter Ei. For an FMC acquisition, N independent reconstructions will be performed.

In the case of a 2D reconstruction, we construct a family of ellipses Γ_{c}={C₁,C₂, . . . } associated with each emitter-receiver pair {(Eᵢ,Rᵢ)}, i=1,2, . . . , with the same emitter Eᵢ, as illustrated in FIG. 5.

For a linear transducer, by assuming that the family Γ_{c} depends on the parameter cₓ (x coordinate of the midpoint C) in a differentiable manner, on the basis of the system of equations (1), the coordinates of the point P of the profile are obtained in the following form:

$$x = {c}_{x} + a \cdot Δ$$

$$z = b \cdot \sqrt{1 - {Δ}^{2}}$$

$$Δ = \frac{- b + \sqrt{{b}^{2} - 4 {ab}^{′} ( {a}^{′} b - {ab}^{′} )}}{2 ( {a}^{′} b - {ab}^{′} )}$$

where a and b are given by (2.3), h=|\vec{h}|/2 is the distance from the center to the ellipse focus and the derivative of b at the midpoint Cⱼ, b′, is given by:

$${b}^{′} = \frac{{aa}^{′} - {hh}^{′}}{\sqrt{{a}^{2} - {h}^{2}}} = \frac{{aa}^{′} - {hh}^{′}}{b}$$

In the discrete case, for the set of N elementary signals {Sᵢ₁,Sᵢ₂, . . . , S_{iN}} associated with the same emitter i, the coordinates of the point Pⱼ, j=1,2, . . . , N−1, in the frame of the sensor are given by the formula (2.4) with a′ⱼ, the discrete derivative, given by the formula (2.5) or (2.5′), of a at the midpoint Cⱼ.

The value of b′ⱼ is for example obtained through the formulae (2.5) or (2.5′) or through

$${b}_{j}^{′} = \frac{{a}_{j} {a}_{j}^{′} - {h}_{j}}{{b}_{j}}$$

The method according to this second variant embodiment executes, for example, the following steps, FIG. 6:

a) arranging the data grouping together the set of signals {Sᵢⱼ} associated with the same emitter i,

b) for each emitter i:
b1) measuring the flight time of the surface echo, tⱼ, for each emitter-receiver pair {Eᵢ, Rⱼ},
b2) constructing the family of ellipses Γ_{c} associated with these emitter-receiver pairs {Eᵢ, Rⱼ} by calculating midpoints Cⱼ, length of the semi-major axis aⱼ and of the semi-minor axis bⱼ which are given by (2.3),
b3) calculating the envelope of the family of ellipses, calculation of the points Pⱼ using the formula (2.4),

c) determining the profile of the piece.

In an analogous manner, 3D reconstruction based on shot point reduces to the calculation of the envelope of the family of ellipsoids Σ_{c}_{ₓ}_{,c}_{_{y}} having two parameters cₓ and c_{y}, with equation (2.6).

Generally, the method of profile reconstruction of a piece according to the invention executes at least the following steps:
Step 1: data corresponding to the signals received on the sensors are arranged by grouping together the signals {Sᵢⱼ} having the same offset: {Sᵢⱼ|j−i=k} (for the first reconstruction variant based on common offset) or the signals associated with the same emitter i (for the second reconstruction variant based on shot point),
Step 2: according to the first variant for each offset (or parameter k) or the second variant, for each emitter i, the flight time of the surface echo is measured for each emitter-receiver pair. This flight time can be obtained by extracting the time of the maximum of the envelope of the signal received, for example. In this case, to circumvent noise, an amplitude threshold S, for example, is applied to the envelope of the signal and the flight time corresponding to the surface echo is said to be measured if the maximum of the envelope of the signal is greater than S. A function T(C) is therefore obtained, corresponding to the flight time of the surface echo as a function of the midpoint C given by (2.3). If the amplitude of the signal received by the surface is less than S, no information on the surface is therefore available. This missing flight time can be determined, for example, through an interpolation on the basis of the two closest non-zero values T(C), so as to make available a regularly sampled signal T. We note here that the interpolation of the flight times is not a necessary step.
Step 3: the points Pj of the sought-after profile are calculated. Accordingly, a family of ellipses associated with emitter-receiver pairs {Ei, Rj} is firstly constructed. The midpoints q, length of the semi-major axis aⱼ and of the semi-minor axis bⱼ are calculated by (2.3). The calculation of the envelope of the family of ellipses is performed using the formulae (2.4).

The application of the scheme described hereinabove allows the points of the profile of the piece to be reconstructed locally. The sought-after profile can be obtained, for example, by a polynomial regression on the reconstructed points Pⱼ. In this case, for each abscissa xⱼ of Pⱼ, the profile is described by a polynomial of degree n.

The reconstructed profile is presented, for example, in a CAD file format. In this case, the profile is described by segments linking the set of reconstructed points Pⱼ. According to a variant embodiment, the number of reconstructed points can be reduced with the aid of procedures for reducing the number of facets such as for example the radii of curvature procedure or the linearization procedure based on linear regression. It is also possible to use other known procedures making it possible to smooth the points obtained and to present the profile in a more easily utilizable format or according to the processings implemented.

FIG. 5 represents an exemplary implementation of the first variant of the method.

The FMC acquisition has been carried out while immersed, on a piece with a sinusoidal profile, as is represented in FIG. 2. The test is performed with the aid of a 2 MHz linear sensor with an 89.4 mm aperture and composed of 64 elements of width 1.2 mm. The material constituting the piece is homogeneous and made of stainless steel.

In the case of a reconstruction presented in FIG. 5, the points of the profile are reconstructed on the basis of 64 signals with an amplitude threshold S=−12 dB.

The reconstruction based on common offset (FIG. 5) is performed for 10 different offsets (k=0,1, . . . 9) with S=−12 dB.

The reconstruction based on shot point (FIG. 6) is performed by utilizing all the signals (64 shots) with S=−6 dB

Without departing from the scope of the invention, the examples given in conjunction with FIGS. 2 to 6 can be used with waves other than ultrasound waves and a different propagation medium from water. For example it is possible to use any wave or disturbance which will be adapted for measuring the flight time or some other parameter, following the reflection of this wave on the piece, characterizing the profile of the piece. The propagation medium can be a fluid, a gas or a solid medium exhibiting good propagation properties.

These examples can also apply when it is sought to characterize the profile of the “back” of a piece instead of its surface.

The examples given previously relate to non-destructive testing by ultrasounds. Without departing from the scope of the invention, other technical sectors using the same physics of waves could be envisaged, for example seismic imaging, based on elastic waves.

The method according to the invention exhibits notably the following advantages: faster determination of the profile and simplicity of implementation while considering a more significant number of processed data than the number used in the electronic scanning technique according to the prior art.

1. A method for reconstructing a profile of a piece, by using an emitter/receiver device comprising N elements, said device being adapted for emitting a wave propagating in a medium, comprising at least the following steps:
A) gathering the signals Si,j reflected by the piece subjected to the wave,
B) measuring the flight time of the surface echo tj for several emitter-receiver pairs {Eᵢ, Rⱼ},
C) constructing the family of ellipses Γ_{c} associated with these emitter-receive pairs {Eᵢ, Rⱼ}, by calculating midpoints cⱼ, with:
a=t·v/2
b=\sqrt{a²−h²}
where a is the length of the semi-major axis, b the length of the semi-minor axis of the ellipse, h=|\sqrt{h}|/2 is the distance from the center to the ellipse focus, t the flight time of
the surface echo, v the speed of propagation of the wave in the medium,
D) calculating the envelope of the family of ellipses Γ_{c},
E) determining on the basis of this envelope the coordinates of the points Pi constituting the profile of the piece, the coordinates (xⱼ, zⱼ) of the points Pⱼ in the frame of the emitter-receiver device being defined in the following manner:
$${x}_{j} = {c}_{x , j} + {a}_{j} \cdot {Δ}_{j}$$
$${z}_{j} = {b}_{j} \cdot \sqrt{1 - {Δ}_{j}^{2}}$$
$${Δ}_{j} = \frac{- {b}_{j} + \sqrt{{b}_{j}^{2} - 4 {a}_{j} {b}_{j}^{′} ( {a}_{j}^{′} {b}_{j} - {a}_{j} {b}_{j}^{′} )}}{2 ( {a}_{j}^{′} {b}_{j} - {a}_{j} {b}_{j}^{′} )}$$
where a′ⱼ and b′ⱼ are respectively the discrete derivatives of a and b at the midpoint Cⱼ, and
the values of a′j and/or of b′j are obtained on the basis of the formulae:
$${a}_{j}^{′} = \frac{{a}_{j + 1} - {a}_{j}}{{c}_{x , j + 1} - {c}_{x , j}}$$
or
$${a}_{j}^{′} = \frac{{a}_{j + 1} - {a}_{j - 1}}{{c}_{x , j + 1} - {c}_{x , j - 1}}$$
and/or
$${b}_{j}^{′} = \frac{{a}_{j} {a}_{j}^{′} - {h}_{j}}{{b}_{j}}$$
C_{x,j+1}; Cₓⱼ₋₁ are the coordinates of the midpoint Cⱼ₊₁ or Cⱼ₋₁.

2. The method as claimed in claim 1, wherein emitter-receiver pairs {Eᵢ, Rⱼ} are used such that the distance k is identical for all the emitter-receiver pairs {Eᵢ, Rⱼ} and the steps of claim 1 are executed to obtain the profile of the piece.

3. The reconstruction method as claimed in claim 2, wherein a two-dimensional emitter-receiver device is used and the envelope of a two-parameter ellipsoid family is determined.

4. The reconstruction method as claimed in claim 1, wherein the set of signals associated with one and the same emitter Eᵢ is grouped together and the signals for the receivers Rj are acquired, with i different from j.

5. The reconstruction method as claimed in claim 4, wherein a two-dimensional emitter-receiver device is used, and the envelope of a two-parameter ellipsoid family is determined.

6. The reconstruction method as claimed in claim 1, wherein the wave is an ultrasound wave.

7. The reconstruction method as claimed in claim 1, wherein to determine the flight time corresponding to the surface echo, a threshold value S is used, the envelope of the signal received is compared and if the value of the envelope is less than the threshold value, an interpolation procedure based on the two closest values is used to find the missing value.
